(19) United States
(12) Patent Application Publication
(10) Pub. No.: US 2009/0132596 A1
(43) Pub. Date: May 21, 2009

(54) DEVICE AND METHOD FOR SETTING ODOR

(75) Inventor: FENG-HSING WANG, Tainan County (TW)

Correspondence Address: ROSENBERG, KLEIN & LEE, 3458 ELLICOTT CENTER DRIVE-SUITE 101, ELLICOTT CITY, MD, 21043, US

(73) Assignee: ALTEK CORPORATION, Hsinchu (TW)

(21) Appl. No.: 12/243,378

(22) Filed: Oct. 1, 2008

(30) Foreign Application Priority Data
Nov. 21, 2007 (TW) 96144061

(51) Int. Cl. G06F 17/30

(52) U.S. Cl. 707/104.1; 707/E17.009

(57) ABSTRACT

The present invention is related to a device and a method for setting odor so as to solve the shortage that conventional digital cameras can not attach odor within the digital image files. The present invention provides an Add Odor option and the sub-menu thereof in the operation interface of the digital cameras for the user to add the desired odor to the selected digital image files, and forms digital image files which contain odor information. When browsing the digital image files containing odor information, the odor can be dispersed through an odor dispersing unit.

### BACKGROUND OF THE INVENTION

1. Field of the Invention

The present invention is related to a device and a method for setting odor, and more particularly to a device and a method for setting a designated odor to digital images stored in a handheld camera.

2. Description of Related Art

Owing to the development of technology, nowadays digital cameras not only provide the basic photographic function, but also provide extra functions such as sound recording and still and moving image recording. Users can easily record voice, sounds, still images, or movies using such digital cameras. However, there are still some functions that digital cameras cannot provide. For example, if a user wants to add odor to a digital photos for increasing the pleasure while viewing the digital photos, obviously, current digital cameras cannot provide such function to satisfy the demand of the user.

### SUMMARY OF THE INVENTION

To solve the drawback about users cannot set odor to their digital photos, as described above, the present invention provides a device and a method for setting odor.

The object of the present invention is to add odor information into digital photo files, which are photographed by a photographic device (such as digital camera, PDA or video camera), for increasing the interest and additional value of a digital camera.

To achieve the object described above, the present invention provides a set-odor method for a photographic device. This method processes at least one digital image file stored in the photographic device to form the digital image files with odor information. The method includes steps of accessing the digital image file; displaying an operation interface with plural function options; selecting at least one odor; and writing the index of the odor selected into a particular area of the file containing the digital image selected.

To achieve the object described above, the present invention provides a set-odor device for a photographic device. It includes a digital image storage, an odor database, a digital image file selecting unit, an operation interface, and a combination unit. The digital image storage stores at least one digital image file. The odor database has a list which contains at least one predefined odor index. The digital image file selecting unit receives a digital image file selection signal from the user and selects a desired digital image file from the digital image storage according to the digital image file selection signal. The operation interface receives a set-odor instruction from the user and selects the desired odor from the odor database according to the set-odor instruction. The combination unit combines the desired digital image file selected with the index of the odor selected to form a file containing both the digital image and odor information. By operating the photographic device via the mentioned operation interface, the user can add the desired odor information to the desired digital image file, and finally obtain a digital image file containing an image data and the odor information.

The photographic devices (such as, digital cameras, PDAs or video cameras) which apply the present invention only need to have an odor database. If there is the need of immediately dispersing the odor when viewing the digital image file containing odor information, an odor dispersing unit should be included.

There are two examples presenting here to demonstrate how the invention presented can be used. The first example is, if the user wants to browse the digital image file in a computer, and the computer used has already had an odor dispersing unit and a digital image browser, which is capable of recognizing the odor information contained in the digital image file, installed, then the user can view the digital image file and smell the odor at the same time. That is, when the digital image browser loads a digital image file which contains the odor information, it will transmit the odor information stored in an EXIF section of the digital image file to the odor dispersing unit. After the odor dispersing unit receives the odor information, it will disperse the corresponding odor. Another example is, if the user wants to print the image file containing the odor information, and the printer used has the odor printing function, then the user can have a printed copy of the digital image file which disperses the designated odor. That is, the printer will recognize the odor information and attach the molecules of the corresponding odor on the paper when printing.

### BRIEF DESCRIPTION OF THE DRAWINGS

It is more readily appreciated to refer to the following detailed description, when taken in conjunction with the accompanying drawings, so that the foregoing aspects and many of the attendant advantages of this application will become better understood, wherein:

FIG. 1 is a block diagram showing a device for setting odor according to the present invention;

FIG. 2A is a schematic view showing an operation interface according to the present invention;

FIG. 2B is a schematic view showing the sub-menu of Add Odor according to the present invention; and

FIG. 3 is a flow chart showing a method for setting odor according to the present invention.

### DETAILED DESCRIPTION OF PREFERRED EMBODIMENTS

Although the current photographic device already possesses many functions, it would be better if a designated odor can be added to the digital image file. That is, the digital image file which contains the digital image data can also contain the digital odor information. Having such feature will increase the interest and additional value of digital cameras.

Following description explains how the odor information can be added to a digital image file. For simplicity, the following description is based on the photographic devices, but it should be notice that this should not be the limitation of the present invention.

Most digital cameras store photographed images in JPEG file format. As adopting the JPEG format, the image data are compressed in a destructive way (distortion), so that the size of the digital image can be reduced significantly. To achieve this, the JEPG algorithm firstly converts the digital image from spatial domain into frequency domain. Then, based on the concept of human eyes are insensitive to high frequencies, part of the high frequencies are removed according to a quantization parameter. Also, the file format of JPEG allows extra information to be embedded in the header (namely, the Meta character is added to the standard head section) of the file, which is called EXIF (Exchangeable image file format) information. Most digital cameras embed the settings used for taking the digital image, such as focus setting, date and time, into the EXIF section of the JPEG file while storing the photographed images as files.

In the present invention, the explanation of the device for setting odor is based on digital cameras. For simplicity, the following explanation only describes the related circuits and actions, but it should be known that there still have other necessary circuits and mechanisms contained in the digital camera.

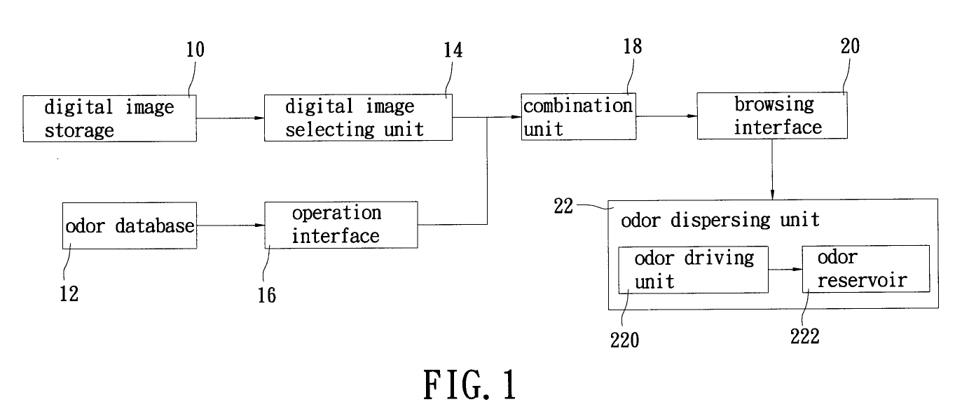

Please refer to FIG. 1, which shows the block diagram of the set-odor device of the present invention. The device for setting odor in the present invention is designed for photographic devices, which can be digital cameras or PDAs. This kind of devices include a digital image storage 10, an odor database 12, a digital image selecting unit 14, an operation interface 16, a combination unit 18, a browsing interface 20 and an odor dispersing unit 22.

The digital image storage 10 and the odor database 12 can be integrated in one memory unit or can be individually installed in different memory units. Here, the memory unit can be a memory card or a flash memory. The digital image storage 10 which stores the digital image taken has at least one digital image file stored therein. The odor database 12 has a list which contains at least one predefined odor index therein. The digital image selecting unit 14 is used to select one of the digital image files stored in the digital image storage 10. The operation interface 16 is a user interface for the user to apply various kinds of operations to the digital images or the digital camera itself. It is similar to the user operation interface of the conventional digital camera.

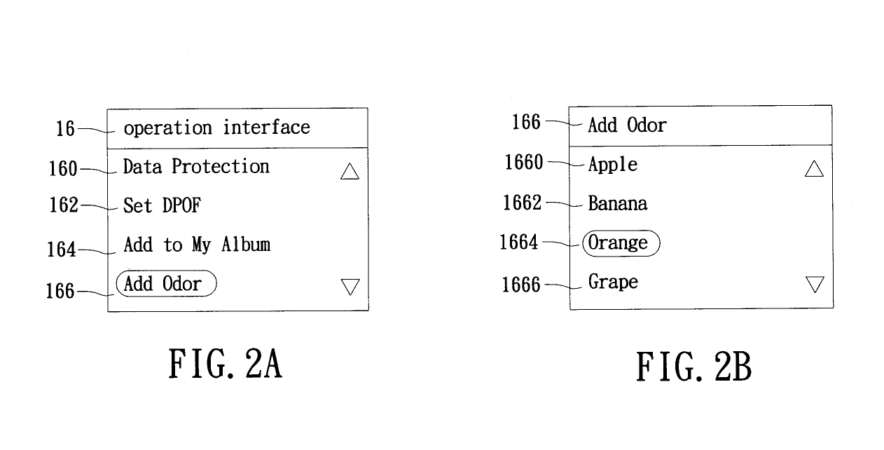

Please refer to FIGS. 2A and 2B, which are the schematic views showing the operation interface 16 of the present invention and the sub-menu of Add Odor, respectively. In FIG. 2A, the operation interface 16 provides some options like Data Protection 160, Set DPOF (Digital Print Order Format) 162, Add to Album 164 and Add Odor 166. Then, the sub-menu of Add Odor may include several kinds of odors like fruit odor, vapor odor, air odor or other natural odors. Here, in FIG. 2B, it demonstrates some fruit-based odors as example, such as Apple 1660, Banana 1662, Orange 1664 and Grape 1666. Compared with the conventional operation interface, the operation interface of the present invention provides the particular option of Add Odor.

The combination unit 18 combines the digital image selected by the digital image selecting unit 14 with the index of the odor selected via the operation interface 16 together, and forms a digital image file containing the image data and odor information. The user may browse digital image file stored in the digital image storage 10 via the browsing interface 20. The odor dispersing unit 22 at least includes one odor driving circuit 220 and one odor reservoir 222. The odor driving circuit 220 includes at least one odor driver, and the odor reservoir 222 may contain multiple physical odors, such as fruit odor, vapor odor, air odor or other natural odor.

When the user browses the digital image file containing odor information via the browsing interface 20, the browser will detect the odor information. The browsing interface 20 will send a corresponding signal to the odor driving circuit 220 in according with the odor information. The odor driving circuit 220 then controls the odor reservoir 222 to disperse the desired physical odor.

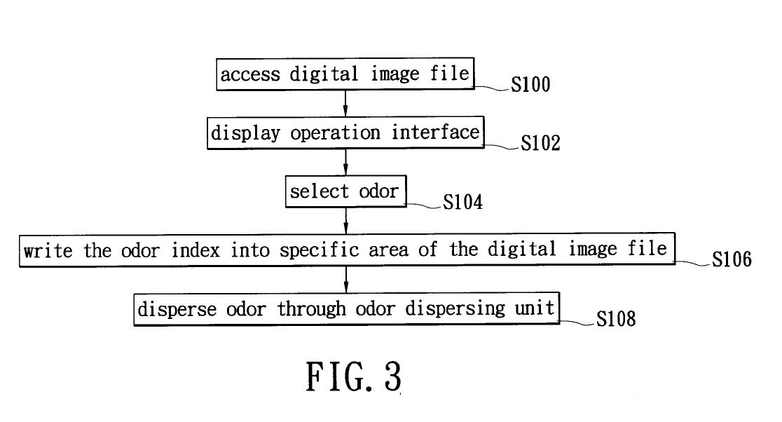

Please refer to FIG. 1 and FIG. 3, which is the flow chart of the set-odor method of the present invention. The method for setting odor in the present invention is applied to a photographic device for forming at least one digital image file with odor from the digital image files stored in the photographic device. Following description takes digital cameras as the examples for explaining the method for setting odor, but this should not be the limitation of the present invention.

First, user turns on the digital camera. By operating the buttons or touch panel of the digital camera, the user may access the digital image files stored in the memory (S100) for selecting the desired digital image file. Then, on the screen of the digital camera, an operation interface with multiple options is shown (S102). Please refer FIG. 2A and FIG. 2B as the examples of the operation interface. The operation interface 16 may provides several options such as Data Protection 160, Set DPOF (Digital Print Order Format) 162, Add to Album 164, Add Odor 166 and others. Through selecting the option of Add Odor, the user may enter the Add Odor 166 sub-menu to select at least one odor (S104). After the user selects the desired odor, the firmware of the digital camera will write the index of the selected odor into a specific area of the digital image file (S106). Here, the specific area can be the EXIF section described above. Finally, an image file which contains the odor information is produced and stored in the digital image storage 10.

To browse the digital images with or without the odor information, the browsing interface 20 can be used. When the browsing interface 20 loads a digital image file which contains odor information, it detects the odor information and transmits a corresponding signal to the odor driving circuit 220. After receiving the corresponding signal, the odor driving circuit 220 controls the odor reservoir 222 to disperse the desired physical odor. Thereby, as the user browses the digital image files with odor information, the odor dispersing unit may disperse the corresponding physical odor at the same time (S108).

The photographic devices (such as, digital cameras, PDAs or video cameras) which apply the present invention only need to have an odor database. Via the operation interface, the user can easily add the desired odor to the digital image files. Further, if the photographic devices have the need of disperse the odor contained in the digital image file, an odor dispersing unit is suggested.

The applications of the present invention can be: First, if the computer used for browsing the digital image file with odor information is connected to an odor dispersing unit, and an image browser capable of recognizing the odor information is installed in the system, and then the user can view the picture and smell the odor together. That is, when the user uses the image browser to view the digital image file containing odor information, the image browser can detect the odor information stored in the EXIF section of the digital image file and transmit the corresponding signal to the odor dispersing unit. After the odor dispersing unit receives the corresponding signal, it can disperse the corresponding odor. Secondly, if the user wants to print the digital image containing the odor information, and the printer used possesses the ability of recognizing the odor information and odor printing, then the user can have a printed version of the digital image dispersing the designated odor.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A method of setting odor for adding at least one odor information to at least one digital image file stored in a photographic device, the method comprises the steps of:
accessing the digital image file;
displaying an operation interface with plural function options;
selecting at least one odor; and
writing the odor information of the odor into a specific area of the digital image file.

2. The method as claimed in claim 1, wherein the function options at least include options of data protection, set DPOF (Digital Print Order Format), add to album and add odor information.

3. The method as claimed in claim 2, wherein the step of displaying the operation interface with plural function options further comprises the step of selecting the option of add odor information.

4. The method as claimed in claim 1, further comprises steps of:
browsing the digital image file with the odor information; and
dispersing the odor through an odor dispersing unit while browsing the digital image file.

5. A device of setting odor for a photographic device comprises:
a digital image storage, for storing at least one digital image file;
an odor database, for storing at least one odor information;
a digital image file selecting unit, for receiving a digital image file selection signal entered by a user so as to select the desired digital image file from the digital image storage;
an operation interface, for receiving a setting odor instruction from the user, selecting desired odor information from the odor database according to the setting odor instruction and producing an operation output signal; and
a combination unit, for combining the desired digital image file and the desired odor information according to the operation output signal.

6. The device as claimed in claim 5, further comprises a browsing interface for browsing the digital image file with the odor information combined by the combination unit or without odor information.

7. The device as claimed in claim 5, further comprises an odor dispersing unit for dispersing the odor specified in the digital image file while the user browses the digital image file through the browsing interface.

8. The device as claimed in claim 7, wherein the odor dispersing unit is built into the photographic device or is an independent external odor dispersing unit.

9. The device as claimed in claim 8, wherein the odor dispersing unit comprises an odor driving circuit and an odor reservoir.

10. The device as claimed in claim 5, wherein the digital image storage and the odor database are installed in a memory unit.
